(19) United States
(12) Patent Application Publication
(10) Pub. No.: US 2004/0229520 A1
(43) Pub. Date: Nov. 18, 2004

(54) Contact to connect a wire to an electronic instrument

(76) Inventor: Han-Yi Tsai, Taipei Hsien (TW)

Correspondence Address: Troxell Law Office PLLC, Suite 1404, 5205 Leesburg Pike, Falls Church, VA, 22041, US

(21) Appl. No.: 10/436,348

(22) Filed: May 13, 2003

(51) Int. Cl. H01R 4/48

(52) U.S. Cl. 439/862

(57) ABSTRACT

A contact to connect wires to electronic instruments includes an elongated body. The elongated body has a front, a rear, two opposite sides and a clamp. The front of the elongated body is bent to form a contact point by stamping. The clamp is formed at the rear of the elongated body, has multiple clamping fingers and recesses and connects a wire to the contact. The clamping fingers are formed complementarily on opposite sides of the elongated body. The recesses are defined transversely in the elongated body and respectively in the clamping fingers. Consequently, the clamp will efficiently grip and hold a wire when a stamp machine rolls the clamping fingers around the wire so the clamping fingers squeeze the wire.

### BACKGROUND OF THE INVENTION

1. Field of the Invention The present invention relates to a contact, and more particularly to a contact to connect a wire to an electronic instrument without solder.

2. Description of Related Art

Solder is used extensively to connect wires to electronic instruments. However, the application of the solder is inconvenient, and solder joints formed are often ineffective because of improper soldering techniques, improper solder or improper flux. Imperfections in a solder joint can cause arching, intermittent current flow, a completely open circuit or an electrical joint that is susceptible to vibration and shock.

Therefore, various electronic products or instruments today use contacts to conveniently and quickly connect wires to the electronic instruments. However, sizes of the wires and electronic instruments and products are made as small as possible. As the electronic instruments become smaller, separation between adjacent contact points in the electronic instruments is also reduced. The contact must be fabricated with a small size to accommodate for the requirements. However, when conventional contacts are fabricated in a small size, the contacts will not efficiently hold the wires in position. If the contacts cannot firmly connect to the wires, the wires will disconnect from the contacts. Therefore, the electronic instruments will not work.

To overcome the shortcomings, the present invention provides a contact to efficiently connect wires to electronic instruments to mitigate or obviate the aforementioned problems.

### SUMMARY OF THE INVENTION

The main objective of the invention is to provide a contact to connect a wire to an electronic instrument without solder and efficiently connect to the wire.

The contact comprises an elongated body. The elongated body is made of conducting material and has a front, a rear, two opposite sides, a clamp and multiple recesses. The front of the elongated body is stamped to form a contact point by stamping. The clamp is formed at the rear of the body and has multiple clamping fingers that are formed alternately on opposite sides of the elongated body. Each recess is defined transversely in the elongated body and corresponds to one of the clamping fingers. A stamping type machine rolls the clamping fingers tightly around a wire and squeezes the wire into the recesses to efficiently grip and hold the wire in the clamp.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a contact in accordance with the present invention;

FIG. 2 is an operational perspective view of the contact in FIG. 1;

FIG. 3 is an operational top plan view of a contact block for an electronic product with multiple contacts in FIG. 1;

FIG. 4 is an enlarged side plan view of the contact block in FIG. 3 with a contact in FIG. 1;

FIG. 5 is an enlarged rear plan view of the contact in FIG. 1;

FIG. 6 is an enlarged, operational rear plan view in partial section of the contact in FIG. 2; and

FIG. 7 is an enlarged operational top plan view of a second embodiment of a contact in accordance with the present invention.

### DETAILED DESCRIPTION OF PREFERRED EMBODIMENT

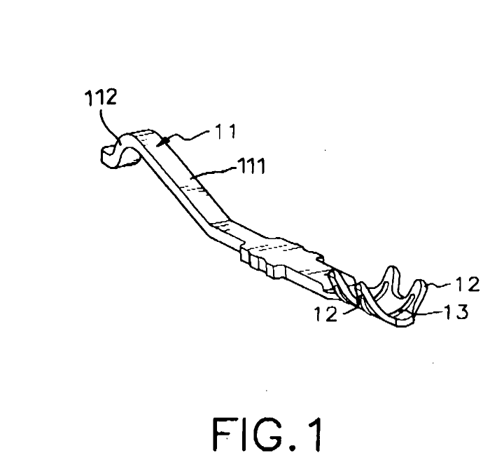

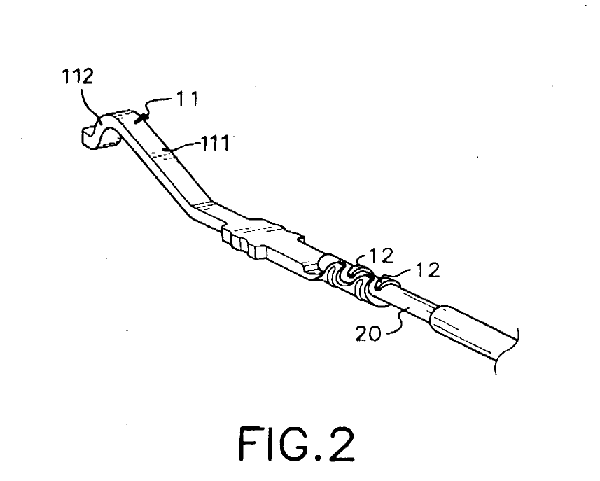

With reference to FIGS. 1 and 2, a contact in accordance with the present invention comprises an elongated body (not numbered) that is made of conducting material. The elongated body has a front (11), a rear (not numbered), two opposite sides (not numbered) and a clamp (not numbered). The front (11) of the elongated body is bent to form a contact feature, such as a contact point (not numbered) by stamping.

The clamp is formed at the rear of the elongated body and comprises multiple curved clamping fingers (12) and recesses (13). The curved clamping fingers (12) are formed on the two opposite sides of the elongated body by stamping. Also, the curved clamping fingers (12) are arranged complementarily on the two opposite sides of the elongated body. The recesses (13) are stamped transversally in the elongated body and respectively in the curved clamping fingers (12).

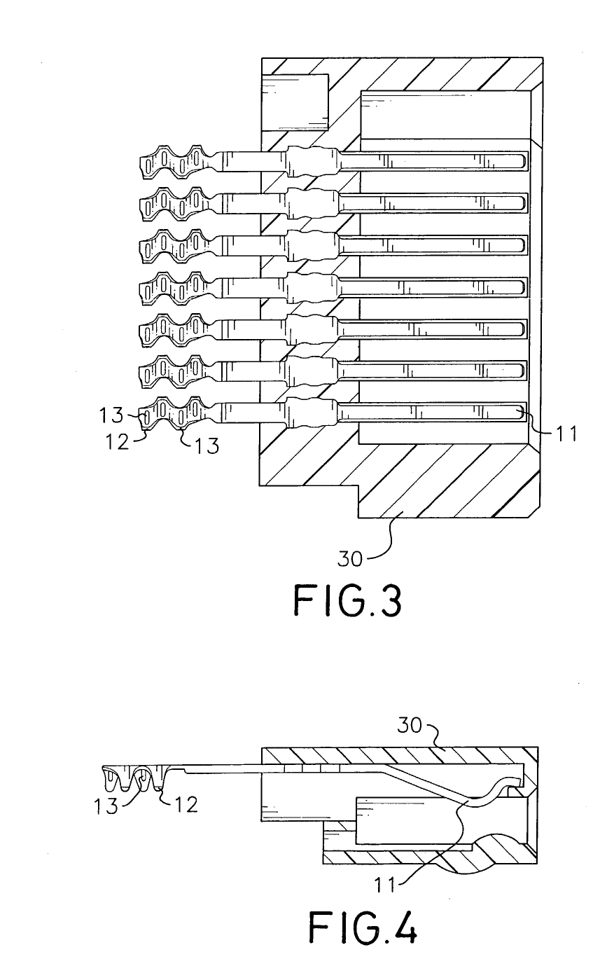

With reference to FIGS. 3 and 4, the fronts of the contacts are inserted respectively into slots (not numbered) in a contact block (30) of an electronic instrument (not shown), and the contact point of each contact efficiently contacts a wire (not shown) mounted a slot in the contact block (30).

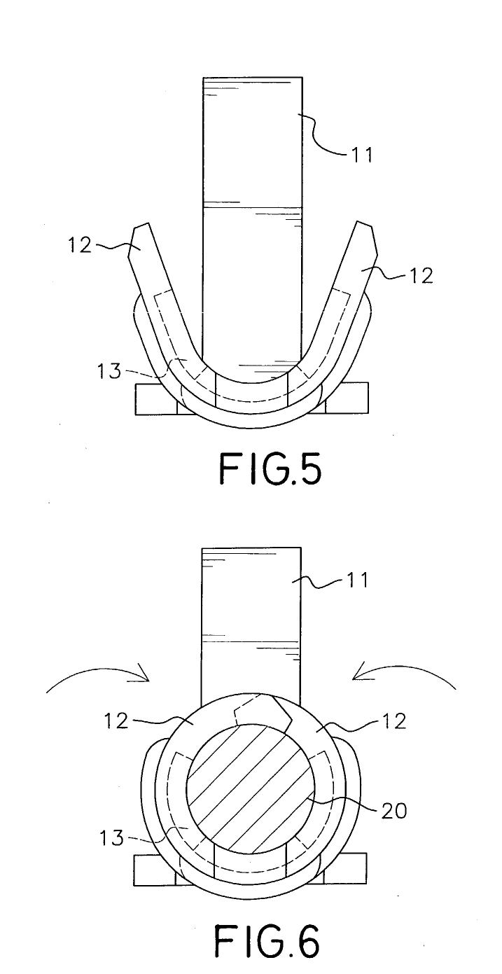

With further reference to FIGS. 2, 5 and 6, the contact clamps a conducting wire (20). The conducting wire (20) has a bare coupling end (not numbered) that is placed along the rear of the elongated body between the curved clamp fingers (12) of the clamp. The curved clamping fingers (12) are rolled around the coupling end of the conducting wire (20) by a stamping machine (not shown). When the stamping machine presses or rolls the curved clamping fingers (12), the coupling end of the conducting wire (20) will also be pressed or stamped. A portion of the coupling end of the conducting wire (20) will be pressed into the recesses (13) such the coupling end of the conducting wire (20) is held more firmly by the clamp.

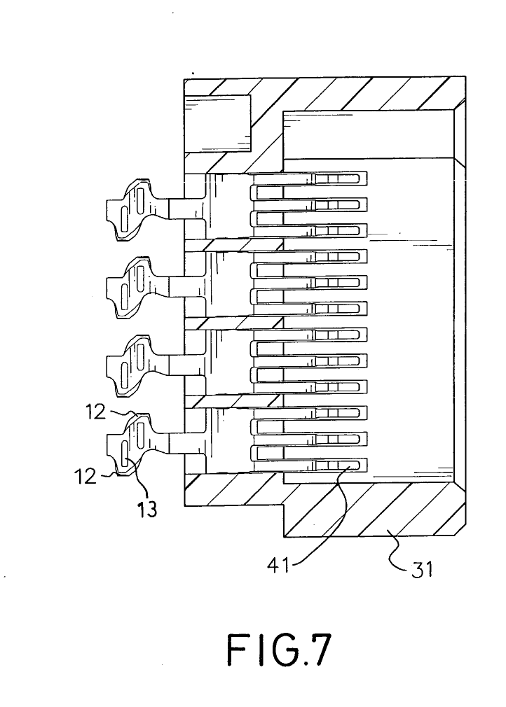

With reference to FIG. 7, an alternative embodiment of a contact in accordance with the present invention further comprises three separated leads (41). The clamp comprises two curved clamping fingers (12) and two recesses (13). The two recesses (13) are defined transversely in the rear of the elongated body and respectively in the curved clamping fingers (12). The contact feature of the foregoing embodiment is implemented with the three separated leads (41) that are formed at front of the elongated body. The front of the enlarged body is divided into the three separated leads (41). Each separated lead (41) has a contact point (not numbered) and is inserted into another contact block (31).

Consequently, the contact will firmly hold the conducting wire (20) and connect the conducting wire (20) to various types of the contact blocks (30, 31) of electronic products or instruments without the solder.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A contact for connecting a wire to an electronic instrument and the contact comprising:
an elongated body having a front, a rear and two opposite sides and the elongated body further having
a contact feature formed at the front of the elongated body;
a clamp formed at the rear of the elongated body, and the clamp having multiple curved clamping fingers formed complementarily on opposite sides of the elongated body; and
multiple recesses defined transversally in the elongated body and respectively in the curved clamping fingers.

2. The contact as claimed in claim 1, wherein the clamp has two curved clamping fingers formed on opposite sides of the elongated body.

3. The contact as claimed in claim 1, wherein the contact feature is three separated leads formed at the front of the elongated body.

4. The contact as claimed in claim 2, wherein the contact feature is three separated leads formed at the front of the elongated body.

5. The contact as claimed in claim 1, wherein the contact feature is a contact point formed at the front of the elongated body.
